(19) United States
(12) Patent Application Publication
(10) Pub. No.: US 2006/0134966 A1
(43) Pub. Date: Jun. 22, 2006

(54) Insulation displacement multipoint connector for electrical plug connectors

(76) Inventor: Jurgen Lappohn, Gammelshausen (DE)

Correspondence Address: Friedrich Kueffner;Suite 910, 317 Madison Avenue, New York, NY, 10017, US

(21) Appl. No.: 11/272,454

(22) Filed: Nov. 10, 2005

(30) Foreign Application Priority Data
Nov. 10, 2004 (DE) 10 2004 065 203.1

(51) Int. Cl. H01R 4/24

(52) U.S. Cl. 439/404

(57) ABSTRACT

An insulation displacement multipoint connector for electrical plug connectors includes connection elements which form at one end thereof an insulation displacement termination area for a connection of electrical conductors without requiring stripping and, at the other end, a plug contact area for a multipoint counter connector. The insulation displacement termination area has flat, slotted insulation displacement terminals. The connection elements are arranged such that for one row of plug contacts of the connection elements embedded next to each other, the insulation displacement terminals of these connection elements are located in several rows in the insulation displacement multipoint connector.

### BACKGROUND OF THE INVENTION

1. Field of the Invention

The present invention relates to an insulation displacement multipoint connector for electrical plug connectors, with combined connection elements which form at one end an insulation displacement termination area for a connection of electrical conductors without requiring stripping and, at the other end, a plug contact area for a multipoint counter connector, wherein the insulation displacement termination area has flat, slotted insulation displacement terminals.

2. Description of the Related Art

Insulation displacement connectors are frequently used for contacting electrical conductors without requiring stripping which comprise an area of a metal stamped and bent part equipped with an insulation displacement terminal contact slot for contacting with an electrical conductor to be connected, and an area of a metal stamped and bent part equipped with a plug contact component for corresponding multipoint counter connector elements. In this way, several connection elements are housed in an insulating case arranged in a single row or in multiple rows and so form a multipoint connector. Such an electric multipoint connector is described for example in DE 199 53 593 A1. The connection elements according to this publication each consist of one stamped metal strip bent in a u-shape which is bent perpendicularly and identically around two parallel bend regions positioned transversely to the longitudinal direction of the stamped metal strip and spaced apart from each other, such that a spring arm base plate for two contact spring arms each with a keyhole-like insulation displacement termination device is formed.

The connection elements accordingly have a complicated design and require a considerable amount of space.

DE 197 32 182 C1 shows, for example, series terminals with two flat, mostly parallel insulation displacement contact legs which are bent from a base.

### SUMMARY OF THE INVENTION

The invention is based on the object to provide an insulation displacement multipoint connector with one or multiple rows for electric plug connectors comprising connection elements which can be manufactured relatively easily and are of the narrowest possible build with constant functionality. Furthermore, such an insulation displacement multipoint connector shall be producible by means of modern manufacturing techniques and in a miniaturized design.

This object is met by an insulation displacement multipoint connector for electric plug connectors which has connection elements arranged in one or multiple rows. The connection elements are such that for one row of plug contacts of the connection elements embedded next to each other, the insulation displacement terminals of these connection elements are located in several rows in the insulation displacement multipoint connector. The plug contacts of the connection elements are located in a row next to each other in the insulation displacement multipoint connector and the insulation displacement terminals of the connection elements are in two rows. The insulation displacement terminals of the connection elements are alternatingly located in two rows in the insulation displacement multipoint connector and the connection elements are inserted with regard to their plug contacts alternatingly offset in opposite directions within a connection element row.

An important crucial point of the invention is also seen in the fact that by means of the disclosed constructional configuration of the bottom case part and the upper case part of insulation displacement multipoint connector, particularly the design and arrangement of the elements on the upper case part for the intake of connection elements and the design of the connection elements themselves, significant advantages are attainable for the inherent fabrication and that of a narrow constructional design. The details for this will still be provided later in the description.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

Throughout all the figures of the drawings identical components are furnished with the same reference numbers.

In the drawing:

FIG. 1 is a perspective lateral view of a complete single-row plug connector,

FIG. 2 is a view onto the interior of the multipoint counter connector of a plug connector,

FIG. 3 is a perspective illustration of an insulation displacement multipoint connector of a plug connector according to FIG. 1 with a removed multipoint counter connector,

FIG. 4 is a perspective view onto the opposite side of the insulation displacement multipoint connector with a disconnected insulation displacement termination connection, and

FIG. 5 is a perspective view of the connector according to FIG. 3 shown in the disconnected state.

### DETAILED DESCRIPTION OF THE INVENTION

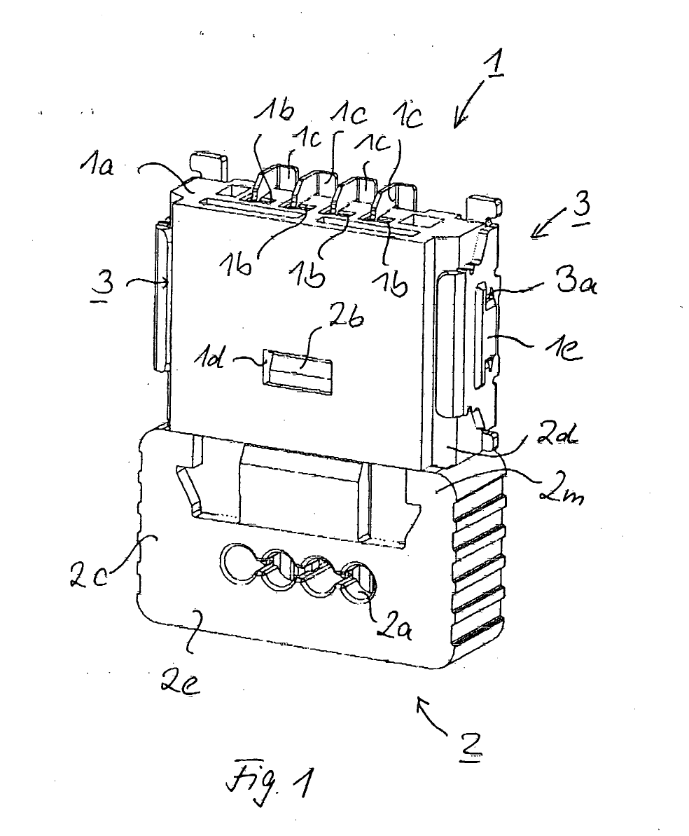

The single-rowed plug connector strip shown in FIGS. 1 to 5 is composed of a multipoint counter connector 1, and an insulation displacement multipoint connector 2 for connecting, in this example, four electric conductors which are inserted into the interior of the insulation displacement multipoint connector 2 through insertion openings 2a. The multipoint counter connector 1 has a case trough la made of insulating material, in which a row of parallel counter plug contacts, not shown herein, are attached and which point in the direction of the plug connection. In the example, four counter plug contacts are arranged in one row. The case trough 1a exhibits on the side opposite the plug connection openings 1b for the terminal lugs 1c which are integrally moulded to the counter plug contacts. With the help of a snap-in slot 1d which corresponds with a notch 2b on the bottom case part 2c of the insulation displacement multipoint connector 2, locks the multipoint counter connector 1 in the plugged state without projecting the insulation displacement multipoint connector 2. This locking with the locking elements 1d and 2b prevents a loosening of the plug connection in the event that vibrations act on the plug connection on the one hand, or that tensile forces act against the plugging direction, which, although below a defined threshold value for disconnecting the multipoint counter connector 1 from the insulation displacement multipoint connector 2, could negatively impact the quality of the plug connection.

Furthermore, the case trough 1a bears at its narrow sides spring-elastic fastening clamps 3 for fastening the plug connector to a base. These fastening clamps 3 snap with their snap-in slots 3a into corresponding locking contours 1e of the case trough 1a.

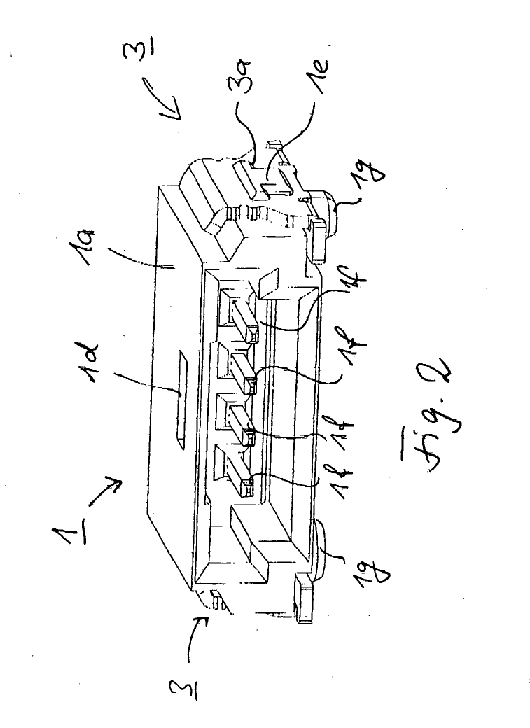

FIG. 2 shows a view into the interior of the multipoint counter connector 1. The four counter plug contacts if which in the present illustration are designed as contact blades can be seen well, inserted in a row in the trough-like insulating case 1a of the multipoint counter connector 1. In addition, small feet 1g are attached at the backside of the trough case 1a. Furthermore, FIG. 2 shows how the fastening clamps 3 with their snap-in slots 3a are snapped over the locking contours 1e at the narrow sides of the trough case 1a.

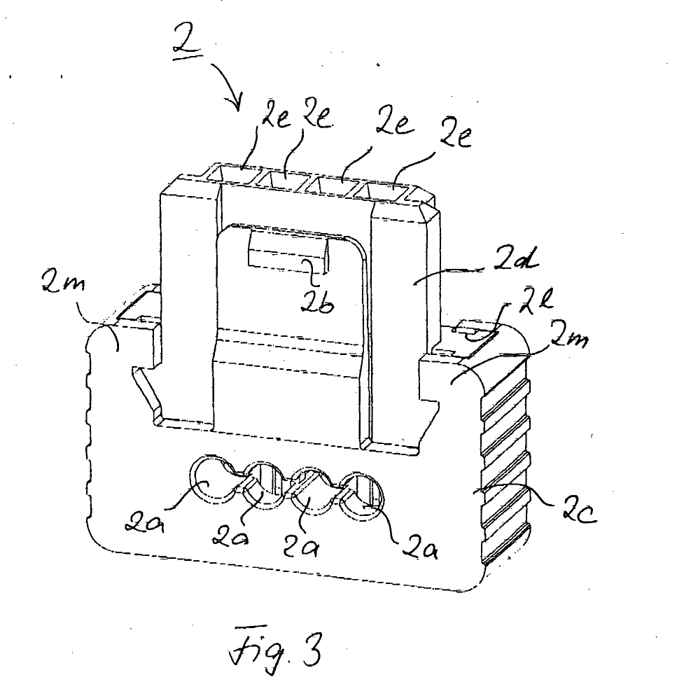

FIG. 3 shows the closed insulation displacement multipoint connector 2. It comprises two attachable case parts 2c, 2d, the bottom case part 2c having insertion openings 2a for the electric conductors to be connected electrically without stripping and the notch 2b, as well as the upper case part 2d having the inserted connection elements, not shown herein, whose plug contacts open into the plug-in chambers 2e. It can also be seen clearly in FIG. 3 that the notch 2b—which creates a lock-in position with the snap-in slot 1d of the multipoint counter connector 1 in a plugged state—is now, according to the constructional design, integrated in the broad side of the body of the bottom case part 2c. By displacing this locking element 2b from the narrow side of the body to the broad side of the body, the grip elements which are provided according to conventional design on the narrow sides of the insulation displacement multipoint connector 2 can be formed in a more variable manner. Additionally, the entire width of such an insulation displacement multipoint connector 2 can also be reduced, which has a very positive affect on the production of miniaturized designs of such plug connections.

Moreover, a specialized design envisions that a recess is arranged in the upper case part 2d of the insulation displacement multipoint connector 2 corresponding to the position of the notch 2b in the bottom case part 2c, wherein a space is formed between the surfaces of the recess and the notch 2b which face each other, so that the notch 2b has more latitude for a transverse motion.

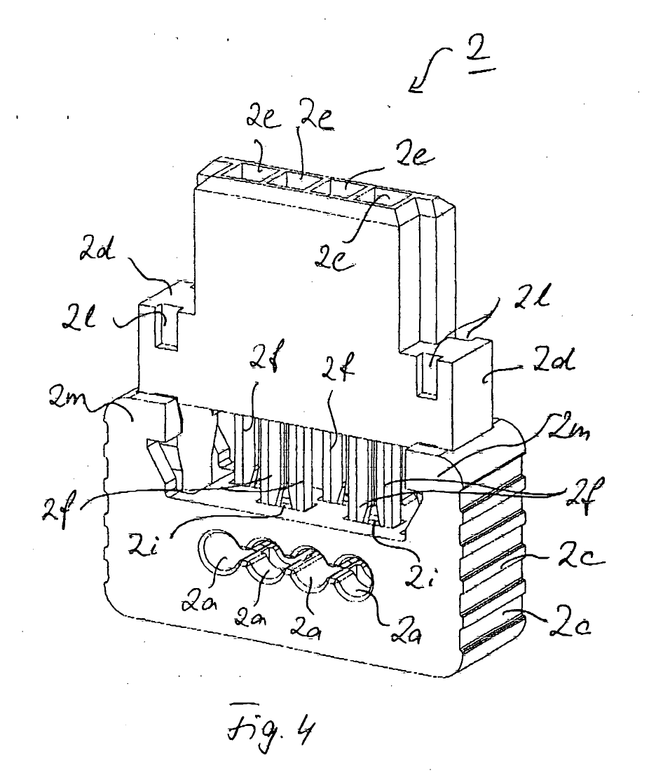

The insulation displacement multipoint connector 2 is shown in FIG. 4 with a disconnected upper case part 2d from the opposite side as in FIG. 3. When the upper case part 2d is withdrawn, the insulation displacement terminals 2f of the connection elements clear the insertion openings 2a for the electrical conductors in the bottom case part 2c. As can be seen, the insulation displacement terminals 2f of the connection elements are alternatingly arranged in two rows, while the plug-in chambers 2e for the plug contacts and thereby also the plug contacts of the connection elements themselves are arranged in a single row with the necessary insulation distance. This is possible due to the wider build of the insulation displacement terminals 2f compared with the plug contacts. The necessary insulation distance of the insulation displacement terminals 2f is achieved by alternatingly arranging the insulation displacement terminals in two rows. Altogether due to this construction, the insulation displacement multipoint connector 2 and therefore the entire plug connector 1, 2 is relatively narrow compared with such plug connectors known in the art which only have single-rowed insulation displacement terminals and are therefore arranged for a wider build. According to the invention, the plug contacts must not be splayed wide apart. Although the insulation displacement terminals 2f, as designed, are arranged in two rows, the insulation displacement multipoint connector 2 and the entire plug connector 1, 2 does not have a deeper build on the whole, since the flat insulation displacement terminals 2e also arranged alternatingly in two rows do not require more depth than the plug contacts.

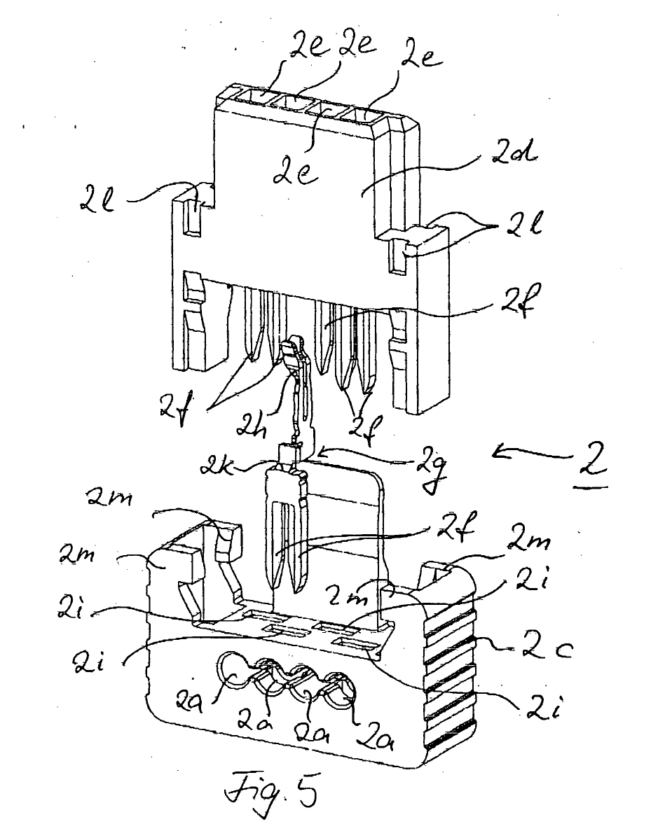

FIG. 5 again clarifies in part the idea of the invention. The upper case part 2d and the bottom case part 2c are separated from each other in this figure. The connection elements 2g are located in the upper case part 2d, of which only three insulation displacement terminals 2f protrude from the upper case part 2d. A connection element 2g is disassembled for illustration. The plug-in chambers 2e in the upper case part 2d for the plug contacts 2h of the connection elements 2g, in the example there are contact springs for the contact blades 1f of the multipoint counter connector 1, are arranged in a single row, the insertion openings 2i for the insulation displacement terminals 2f are arranged alternatingly in two rows. In doing so, the insertion openings 2i are moved together at a lateral distance, such that their total length as viewed across the bottom case part 2c corresponds to the total length of the plug-in chambers 2e across the upper case part 2d. The disassembled connection element 2g exhibits an approximately centric offsetting 2k in the depth of the insulation displacement multipoint connector 1, which makes it possible that the insulation displacement terminal 2f finds its insertion opening 2i (left insertion opening) in the front row as seen by the observer. Likewise, a further connection element 2g is offset for the first row (right insertion opening), which however, is obliterated by the upper case part 2d in the figure.

Both the other connection elements 2g are designed such that the insertion openings 2i are located in the back row as seen by the observer. Usually, these connection elements 2g will consequently be offset opposite to both of the other connection elements 2g. According to a very practical design of the invention, the connection elements 2g are all offset in one direction and then inserted alternatingly pivoted around their longitudinal axis by 180° into the plug-in chambers 2e and hooked. In this way one achieves that only a punching and bending tool is required for the production of the connection elements 2g and the insulation displacement terminals 2e still find their intended insertion openings 2i when assembling the upper case part 2e and the bottom case part 2c. Connection elements which are inserted offset to both directions also make it possible that the two rows of insertion openings 2i are located symmetrically to the centerline of the single-rowed plug-in chambers 2e, which is advantageous with regard to the minimum required depth of the insulation displacement multipoint connector 2.

The connection elements 2g may also have different designs according to the invention. It is possible that only every second connection element 2g is offset, and in this case, by the full amount of the row distance of the insertion openings 2i in the bottom case part 2c. The other connection elements 2g are guided without being offset. The place at which the offsettings 2k are carried out across the length of a connection element 2g depends vastly on the constructional details. In the example, the offsettings 2k are effected approximately in the center between the insulation displacement termination area and the plug contact area.

In the example, the connection elements 2g bear contact springs at the sides of the plug contact 2h. According to a further embodiment, the connection elements 2g bear instead contact blades or contact pins. In this case, the multipoint counter connectors 1 have contact springs.

A four-pole plug connector 1, 2 is shown in the example. It goes without saying that the number of poles is not limited to four, rather any number of poles is feasible.

The invention is also not limited to a single-rowed plug connector 1, 2. For example, it is possible to build two-rowed plug connectors for two-rowed multipoint counter connectors, wherein in that case, the insulation displacement terminals 2f engage with a total of four rows of insertion openings 2i and the connection wires are fed from two sides or from one side in tiers.

For clamping of electrical conductors which are sheathed in plastic without requiring stripping, they must be plugged into the insertion openings 2a. Then, the upper case part 2d in which the connection elements are attached, and the bottom case part 2c are put together, wherein the insulation displacement terminals 2f cut into the insulation to the electrical conductor. Since the terminal areas are minimally offset relative to each other, the mechanical stability of the insulation displacement termination connection is increased. Locking contours 2l, 2m are provided for a robust connection of the upper case part 2d with bottom case part 2c.

All of the embodiments mentioned either in the above description or only shown in the drawings are additional integral parts of the invention, even if they are not especially emphasized or mentioned in the claims. The invention is not limited to the present design, but may be variable in many cases within the scope of the disclosure.

While specific embodiments of the invention have been described in detail to illustrate the inventive principles, it will be understood that the invention may be embodied otherwise without departing from such principles.

I claim:

1. An insulation displacement multipoint connector for electrical plug connectors, comrising
combined connection elements which form at one end thereof an insulation displacement termination area for a connection of electrical conductors without requiring stripping and, at another end, a plug contact area for a multipoint counter connector, wherein
the insulation displacement termination area has flat, slotted insulation displacement terminals,
the connection elements are designed such that for one row of plug contacts of the connection elements embedded next to each other, the insulation displacement terminals of these connection elements are located in several rows in the insulation displacement multipoint connector,
the plug contacts of the connection elements are located in a row next to each other in the insulation displacement multipoint connector and the insulation displacement terminals of the connection elements are in arranged two rows,
and wherein the insulation displacement terminals of the connection elements are alternatingly located in two rows in the insulation displacement multipoint connector and the connection elements are inserted with regard to their plug contacts alternatingly offset in opposite directions within a connection element row.

2. The insulation displacement multipoint connector according to claim 1, wherein identically offset connection elements are inserted alternatingly pivoted by 180° around their longitudinal axes into the insulation displacement multipoint connector.

3. The insulation displacement multipoint connector according to claim 1, wherein only every second connection element of the connection element row is offset in the same direction with regard to its plug contacts and the other connection elements are not offset.

4. The insulation displacement multipoint connector according to claim 1, wherein the offsettings are located approximately centrically in the area of the connection elements.

5. The insulation displacement multipoint connector according to claim 1, wherein the insertion openings arranged in multiple rows for the insulation displacement terminals intersect with or overlap each other in the direction of alignment.

6. The insulation displacement multipoint connector according to claim 1, wherein the insulation displacement multipoint connector has a case with upper and lower case parts which can be put together, wherein the connection elements are fastened in the upper case part and the insulation displacement terminals are inserted into the bottom case part.

7. The insulation displacement multipoint connector according to claim 6, wherein the case parts are locked together by locking contours.

8. The insulation displacement multipoint connector according to claim 1, wherein the plug contacts of the connection elements form two-armed contact springs.

9. The insulation displacement multipoint connector according to claim 1, wherein the plug contacts of the connection elements form contact blades or contact pins.

10. The insulation displacement multipoint connector according to claim 1, wherein the number of poles is discretionary.

11. The insulation displacement multipoint connector according to claim 1, wherein the plug connector has two or more rows.

12. The insulation displacement multipoint connector according to claim 1, wherein the multipoint counter connector has a case trough made of insulation material.

13. The insulation displacement multipoint connector according to claim 12, wherein at least one snap-in slot is provided in the case trough of the multipoint counter connector into which at least one notch of the bottom case part of the insulation displacement multipoint connector locks in the plugged state.

14. The insulation displacement multipoint connector according to claim 13, wherein the case trough of the multipoint counter connector has two fastening clamps which interlock with the snap-in slots behind the locking contours at the narrow sides of the case trough.

15. The insulation displacement multipoint connector according to claim 6, wherein a notch provided on the insulation displacement multipoint connector which serves the locking of the insulation displacement multipoint connector with the multipoint counter connector, is arranged in one of the broad sides of the body of the bottom case part, wherein the notch does not protrude beyond the surface of this broad side of the insulation displacement multipoint connector.

16. The insulation displacement multipoint connector according to claim 15, wherein a recess is provided corresponding to the position of the notch in the bottom case part in the upper case part of the insulation displacement multipoint connector, wherein a space is formed between the surfaces of this recess and the notch which face each other, so that the notch can carry out a transverse motion.
